(19) United States
(12) Patent Application Publication
(10) Pub. No.: US 2024/0062016 A1
(43) Pub. Date: Feb. 22, 2024

(54) Systems and Methods for Textual Classification Using Natural Language Understanding Machine Learning Models for Automating Business Processes

(71) Applicant: Auditoria.AI, Inc., San Jose, CA (US)

(72) Inventors: Tao Tong, Fremont, CA (US); Lattupally Chandrateja Reddy, Telangana (IN); Hai Au, San Jose, CA (US); Anuvrath Ravindranath Joshi, Mountain House, CA (US); Aaron Richard Clifton, Gilbert, AZ (US)

(73) Assignee: Auditoria.AI, Inc., San Jose, CA (US)

(21) Appl. No.: 18/496,794

(22) Filed: Oct. 27, 2023

Related U.S. Application Data
(63) Continuation-in-part of application No. 18/190,867, filed on Mar. 27, 2023.
Application No. 18/190,867 is a continuation of application No. 17/234,666, filed on Apr. 19, 2021, now Pat. No. 11,615,110.
(60) Provisional application No. 63/011,857, filed on Apr. 17, 2020.
(60) Provisional application No. 63/381,248, filed on Oct. 27, 2022.

(51) Int. Cl. G06F 40/30; G06F 40/20

(52) U.S. Cl. CPC G06F 40/30; G06F 40/20

(57) ABSTRACT

In one embodiment, a method for detecting intent of a textual message for a business records process includes receiving a request message, extracting text and metadata from the request message, executing semantic queries to determine an intent of the request message, by, for each semantic query, where the semantic query specifies a machine learning language model to be used, what text and metadata from the message and textual prompt to provide to each machine learning language model, and a formatting template specifying how an expected answer from each machine learning language model should be formatted, providing some of the extracted text and metadata and a textual prompt to each machine learning language model as specified in the semantic query, receiving an answer from each machine learning language model that includes an indication of an intent classification, and performing a corresponding business action in response to the indicated intent classification.

### RELATED APPLICATIONS

The present application claims priority as a continuation-in-part to U.S. patent application Ser. No. 17/234,666, filed Apr. 19, 2021, which claims priority to U.S. Provisional Patent Application No. 63/011,857, filed Apr. 17, 2020, and the present application also claims priority to U.S. Provisional Patent Application No. 63/381,248, filed Oct. 27, 2022, the disclosures of which are hereby incorporated by reference in their entireties.

### BRIEF DESCRIPTION OF THE FIGURES

FIG. 1 illustrates an autonomous business records processing system in accordance with several embodiments of the invention.

FIG. 2 conceptually illustrates a client device in accordance with several embodiments of the invention.

FIG. 3 conceptually illustrates an integration platform system in accordance with several embodiments of the invention.

FIG. 4 conceptually illustrates an example of application specific machine learning models according to a conventional architecture and general-purpose machine learning models with a semantic layer for natural language understanding (NLU) in accordance with several embodiments of the invention.

FIG. 5 illustrates a process for natural language understanding using semantic queries of a semantic layer to query machine learning language models in accordance with several embodiments of the invention.

FIGS. 6A-H show sample code for an LLM query structure to determine the intention of a message in accordance with an embodiment of the invention.

FIGS. 7A, 7B, and 7C show sample code for an entailment query structure to determine the intention of a message in accordance with an embodiment of the invention.

FIG. 8 shows sample training data for use with an entailment model in accordance with an embodiment of the invention.

FIG. 9 illustrates a process for unifying business records data into a database repository in accordance with several embodiments of the invention.

FIG. 10 illustrates a process for creating and executing a smartflow in accordance with several embodiments of the invention.

FIG. 11 illustrates a process for executing a smartflow in accordance with several embodiments of the invention.

### DETAILED DISCLOSURE OF THE INVENTION

Turning now to the drawings, systems and methods for autonomously processing business records data, which can support performing back office business functions, in accordance with embodiments of the invention are disclosed. A number of modern tools and services are available for businesses to collect and manage business data, such as accounts receivable transactions, inventory, employee information, and so on. Some of these services form categories such as Customer Relationship Management systems (CRM) (such as, but not limited to, Salesforce, Zendesk, etc.), Enterprise Resource Planning systems (ERP) (such as, but not limited to, Sage Intacct, Oracle NetSuite, etc.), and others. However, considerable human effort by employees in various roles such as auditors, accounts receivables clerks, financial analysts is necessary to turn the business data into actionable and/or presentable forms such as reports (e.g., auditing, cashflow forecasts, etc.). Moreover, the business data often is drawn from disparate sources and exists in various forms. These task workflows may be implemented differently at different businesses but can follow general common principles.

Systems and methods for automating business processes in accordance with many embodiments of the invention provide a unified system that integrates business data from different sources into a single format. A central integration platform orchestrates collection of business data from various sources and performs tasks using the business data to provide services in an automated hands-off manner. In several embodiments, the collected business data is stored in an unstructured database. Data objects from different sources can have different structure, fields, and/or associated metadata. The integration platform can translate the data objections into a common format stored in an unstructured manner to unify the datasets.

The central integration system can present a uniform interface (for example, via a mobile application or web interface) to a user to capture natural language input (e.g., textual or spoken audio) that describes a task to perform. This described task can be transformed into a smartflow that defines the task in a common language. In some embodiments, a smartflow can be a programmatic expression of a process to be performed that can be associated with a particular customer account or customer system and information pertaining to that customer account or customer system. The smartflow breaks down the task into steps and the information that is used to carry out the steps. It can assign workers (lower level automations) to gather information and orchestrates the bots to perform the steps to completion. In several embodiments, workers can scale horizontally to cover multiple customers, can run continuously until stopped, and can be spawned as scheduled. As will be discussed further below, a smartflow can be implemented as a state model or state machine executing on a computing platform, such that it performs tasks to collect and process data and maintains an awareness of state.

In several embodiments of the invention, executing smartflows can involve interactions with external parties. For example, a business may wish to update tax information for a set of suppliers. The integration platform can identify suppliers from business records data retrieved from ERP systems and electronically send W-9 forms to be completed, for example, by email. Forms can be returned, for example, by email, and the information extracted either digitally or by optical character recognition (OCR).

Integration platforms in accordance with embodiments of the invention can also perform additional routine checks and reports, such as, but not limited to, audit readiness, detecting financial irregularities, and calculating vendor risk. This can all be enabled by collecting business records data and running adaptive automated processes.

In additional embodiments of the invention, the text of an interaction can be classified using natural language understanding (NLU) by machine learning models (e.g., into a set of predefined intent categories, predefined sentiment categories, or predefined document type categories). The intent of a message can be understood as the meaning or objective of the message, e.g., what it is asking or asking for. The detected intent classification can then be used in developing a response, for example, what information should be retrieved, what information should be extracted from the message, and/or what other actions should be performed. In several embodiments, the interactions can be part of a SmartFlow process, and the intent aids in determining how the SmartFlow should be executed.

Maintaining large natural language machine learning models for specific high-level prediction tasks (such as a classification into SmartFlow context, classification into a set of defined intents, classification into a set of defined document types) can be expensive due to overhead related to maintaining/curating training datasets, version management, operational management, etc. Moreover, scaling to support ever growing needs of different top-level applications can be challenging.

It would be preferable to keep a minimum set of general-purpose ML language models and use middle abstraction layers to bridge the gap between application level specific requirements and the underlying more general-purpose ML language models.

Specifically, several embodiments of the invention incorporate into an integration platform a type of middle semantic layer that decomposes the application specific requirements into elementary queries that can be directly executed by each underlying language model, then can also combine the output from the elementary queries with predefined logic to arrive at application level decisions. The execution of these queries can be referred to as intent detection, that makes a determination of the meaning and intention of a particular message and therefore indicates the context (or circumstances) of the interaction.

The middle semantic layer concept can be further expanded to cover the following scenarios:
A set of more than one (heterogeneous) ML language models or quasi-models (anything defined by a set of input/output relation)
An expanded middle processing logic that itself is Turing complete

In this sense, a Turing complete compute engine can be built on top of a set of heterogeneous ML models with each handling a uniquely general-purpose prediction task. Applications built on top would have the ability to deal with all natural language input or alternative input medium (image, sound, etc.) to mimic what human agents sense.

The system may be implemented in a variety of ways, including dedicated computer hardware and software or distributed architectures such as infrastructure tools available to automated web services. In many embodiments of the invention, a system for automating business processes includes applications executing on one or more hardware platforms, user interface components displayed by one or more hardware platforms, and data warehouses stored on one or more hardware platforms. Such hardware platforms may include at least a processor and non-volatile memory containing instructions directing the processor to perform processes such as those described below.

System Architecture

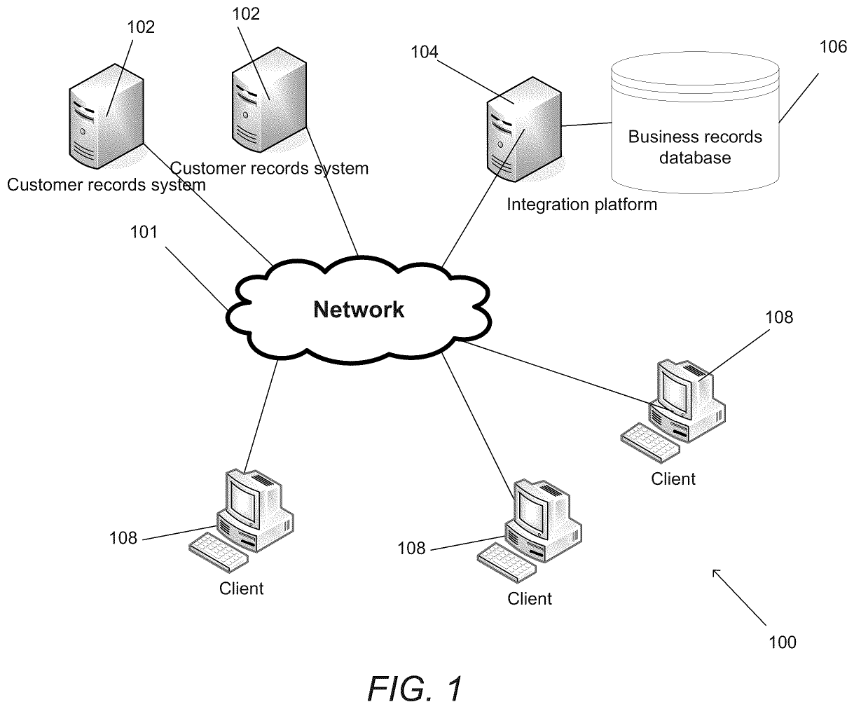

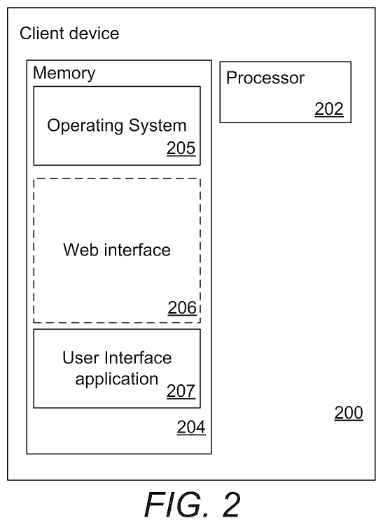

Components of a system for automating business processes in accordance with embodiments of the invention can include software applications and/or modules that configure a server or other computing device to perform processes as will be discussed further below. A system including customer records systems 102, integration platform 104, and client devices 106 communicating over a network 101 as illustrated in FIG. 1. As mentioned further above, information in the form of business records data can be obtained by the integration platform 104 from customer records systems 102. While customer records systems 102 are illustrated as single entities here, it is understood that data sources and data stores be implemented in many forms, such as distributed systems or cloud services. Records provider systems can include Customer Relationship Management (CRM) systems (such as, but not limited to, Salesforce, Zendesk, etc.), Enterprise Resource Planning (ERP) systems (such as, but not limited to, Sage Intacct, Oracle Netsuite, etc.), single sign on (SSO) and identity and access management (IAM) systems (such as, but not limited to, Microsoft and Okta), revenue recognition systems (such as, but not limited to, Revsym, Model N, and Zuora), payroll systems (such as, but not limited to, Intuit and ADP), and vendor management tools, as well as other that provide and mange business information. These can be treated as integration data sources for obtaining records data. The data can be moved using any of a variety of available mechanisms, such as using such as Application Programming Interfaces (API). Additional machines can host external machine learning models that can communicate with the integration platform.

The integration platform in turn stores business records data and other information in a database repository 106. As will be discussed below, business records data may exist in many different forms and formats. Systems in accordance with embodiments of the invention can unify business records data to a single format as stored in a database.

Users may access an interface to the integration platform 104 using client devices 108, which can be any of a variety of computing devices, such as personal computers, mobile devices or phones, or tablets. As will be discussed further below, a user interface on such devices can be used for tasks such as to create and request execution of smartflows, to view information, and generate reports.

A client device in accordance with embodiments of the invention is conceptually illustrated in FIG. 2. The client device 200 includes a processor 202 and memory 204 that includes an operating system 205, web interface 206 and user interface application 207. The user interface application 207 can configure or direct the processor to perform or execute processes such as those described further below with respect to creation of smartflows.

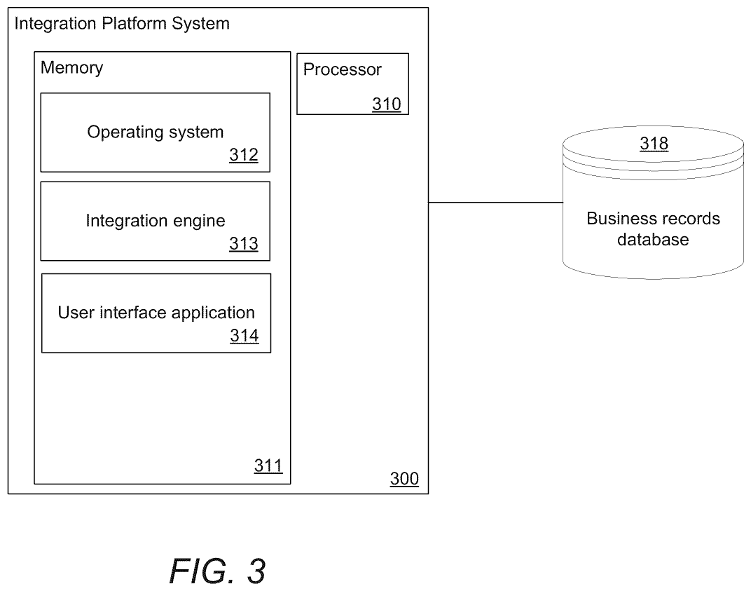

An integration platform in accordance with embodiments of the invention is conceptually illustrated in FIG. 3. The integration platform 300 includes a processor 310 and memory 311 that includes an operating system 312, transformation engine 313, and user interface application 314. The transformation engine 313 can configure or direct the processor to perform or execute processes such as those described further below with respect to normalizing business records data. The integration platform can also access a business records database 318 that stores business records data. One skilled in the art will recognize that an integration platform may be implemented using other computing architectures, for example, as a virtual machine, as a cluster of computers, or using a cloud computing service.

Further embodiments of the invention incorporate e-mail systems. While e-mail systems were traditionally designed for communication, over time, companies have been using e-mail as a tool for workflow wherein they seek approvals, recommendations and decisions. Additionally, e-mail systems can also serve as a data hub for evidentiary data storage as requested for audits and other assurance activities. Illustrative examples of these include approvals for payment reimbursement extensions, decisions to allow clients to split their payments into installments, provide evidence of receipt of goods and services and more. Systems in accordance with embodiments of the invention can leverage technologies including natural language processing (NLP), natural language understanding (NLU), and/or optical character recognition (OCR) along with an ephemeral state machine that can serve as a workflow orchestration engine. By tapping into e-mail systems (such as, but not limited to, Google G Suite and Microsoft Office365) automation flows can be executed across several business processes, while interpreting business context, extracting data from unstructured content, and reconciling them into enterprise applications in the context that enterprises expect. In several embodiments, e-mail data and metadata may be drawn in similar fashion to other types of business records data as discussed below.

Although specific system architectures for automating business processes is described above with reference to FIGS. 1-3, one skilled in the art will recognize that any of a variety of architectures may be utilized in accordance with embodiments of the invention.

### Natural Language Understanding Using Machine Learning and a Semantic Layer

As mentioned further above, interactions with smartflows executed by an integration platform can involve natural language understanding (NLU) to interpret the messages and decide what actions are requested. For example, a smartflow may send notification of payment due to a customer. The customer may ignore the message, or take any of a number of other actions in response, such as dispute an item on invoice, request a copy of the invoice, notify that they will pay in a certain number of days, etc. In many embodiments of the invention, the notification can be an email (e.g., from a server) and the response can be an email (e.g., by a customer's device). NLU can be implemented by any of a variety of machine learning language models.

Modern large neural network language models can be very large (e.g. GPT-3 with 175B parameters) and expensive to train and even to fine tune. They are designed for general-purpose language understanding and generation. To this purpose, they are desired to accommodate a very wide variety of inputs in a human-like fashion. These large language models are typically pretrained with general domain language datasets with no specific emphasis on domain language. It was estimated that it cost ˜$4M to train GPT-3 from scratch on a GPU-farm with hundreds of state-of-art GPUs for weeks.

On the other hand, in real world applications, it is common to present a text input and desire a classification output. For example, one may want to detect the natural intent of input text and classify into one of the predefined intent categories. One may want to detect the sentiment of input text and classify into predefined sentiment categories. One may want to detect the document type of input OCR text content of a document and classify into predefined document categories. Many text classification problems can be generalized into this pattern.

A typical methodology is to build a transfer-learning model to add a classification header to the underlying large language model and turn it into a supervised machine learning problem to transfer learn (train) to solve a specific classification problem. While the transfer learning (training) is much cheaper than training the underlying language model, it still entails large overhead in managing all the problem-specific training iterations, model artifacts and model runtimes through training, supervising, curating, and repeating training. These specialized models can be referred to as application specific models (ASM). For example, one model can determine whether an email is business related, another can direct the message to the appropriate department (e.g., Accounts Receivable), another ca determine what the sender is requesting, another extracts the relevant information from the email, another determines the sender's sentiment or attitude, and yet another can determine some background information such as credit risk. However, it is often impractical to scale the machine learning platform beyond a handful of classification problems.

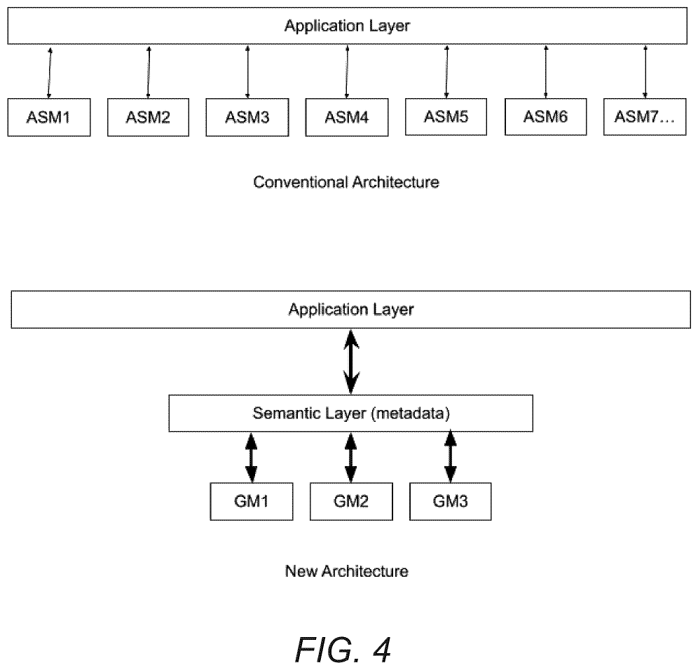

A conventional architecture using multiple ASM's is illustrated at the top in FIG. 4. The ASM's interact directly with the application layer, and many ASM's are required to fulfill various duties.

An alternative methodology is to keep the underlying large language model as “general” as possible, so that systems in accordance with embodiments of the invention use a minimum set of models to handle a large variety of application requirements. Such embodiments can utilize a middle layer between the application requirements and the underlying model(s) as illustrated at the bottom in FIG. 4. These general-purpose or generic models (GM) are not necessarily trained on domain-specific data for the intended application. The middle layer could achieve the following:
Decompose the specific application level requirements into a set of general queries.
Each general query can be directly understood and handled by the underlying model.
The middle layer would assemble the model output for each general query and based on some defined logic to give a final prediction on application level input.

A useful analogy is to look at a general software/hardware compute architecture. Designing a CPU and its peripherals is very expensive. In most cases, it is prohibitive to design application-specific hardware for complex applications. Instead, systems are designed with a general-purpose CPU with its peripherals that supports a common set of machine instructions. Then layers of software abstractions can be built via programming between the lowest level of assembly instructions and application layer to achieve any application requirements. These layers parse any application requirement into smaller instructions. Here, the large natural language ML models would be analogous to the CPU and its peripherals hardware. The software abstraction layers would be analogous to the middle logical query (semantic) layer.

A general-purpose machine learning model can be understood as one that does not require pretraining on domain-specific data (e.g., specific customer data) before use. General machine learning models that can be utilized for intent detection in accordance with embodiments of the invention can include, at least, large language models (LLMs), entailment models and semantic models. The models can give a prediction score that certain conditions are met or that a semantic context matches. Language models may be hosted within an integration platform or may be externally hosted and communicated with.

Large language models typically have the characteristic of conversational interaction and providing human-seeming answers in response to questions. They are trained on very large datasets to remove the need for transfer learning or additional domain-specific training. Some examples are the OpenAI GPT3 family, Megatron, and Bloom LLM.

An entailment model can provide a determination, with an associated prediction score, of whether statement A logically implies statement B. The query structure within a semantic layer for an entailment model can include conditions that “must” be met, one or more conditions that “should” be met (i.e., a specified minimum number of the conditions are met), and/or additional keywords (e.g., “invoice”) using regular expressions. When a “greater than” a certain prediction score is assigned to a condition, it is a positive association meaning that statement A leads to statement B. When a “less than” a certain prediction score is assigned to a condition, it is a contradiction meaning that statement A does not lead to statement B, if statement A then statement B cannot be, or it can be neutral. The query metadata can also include a negative structure section that defines text that is not considered by the model. The conditions and expressions can be nested and customized as appropriate for a particular application. An example entailment model is RoBERTa.

A semantic context model can determine whether a message is relevant to a particular semantic context. For example, the meaning of a message can be interpreted as requesting a copy of an invoice, without an exact word match in a specific order. To set up a semantic context model in some embodiments of the invention, convert every sentence of a set of sentences that help define the semantic context into a numerical vector of a certain dimension (e.g., 1024×1 linear spaces) to encode the semantic meaning. Listing the semantic feature vectors defines a subspace, where each is a point forming a point cloud and the distribution of the point cloud is the subspace. A new input is taking as a point in vector space. Calculating how close it is to the defined point cloud can determine whether it is relevant to that semantic context (defined by the point cloud). An example semantic context model is Sentence-BERT.

When certain semantic features or context are recognized, other tools can be used to extract data from the message. Beyond matching hypothesis statements as context, a semantic model can also be trained to recognize different statements and execute on them like an expanded instruction set.

A semantic layer can include a set of semantic queries, that is code that specifies how to interact with a general ML language model to determine an intent classification from an input. It can achieve an output that is at a level of usefulness as an application-specific language model. This can be thought of as a type of prompt engineering, involving preprocessing of an input to be provided to the language model and postprocessing of the output to be useful to a business records process, e.g., smartflow, or other consumer of the output. Executing semantic queries can be incorporated into natural language processing or natural language understanding portions of processes discussed further below.

### Processes for Classifying Natural Language Expression Using Machine Learning and Semantic Layer

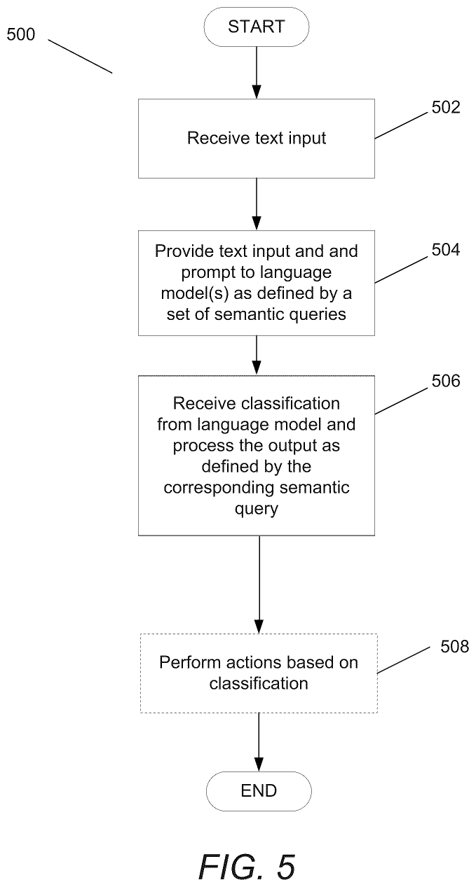

A process for determining the intent of a message using a semantic layer to interact with a ML language model in accordance with embodiments of the invention is illustrated in FIG. 5. In certain embodiments the process 500 can be performed on or by an integration platform.

The process 500 includes receiving (502) a text input. As discussed further above, the text input can be from an email or other message. For example, an email can be received that requests an invoice, containing the text “Please send me the invoice.”

At least a portion of the text input and metadata of the message as defined by a semantic query are provided (504) to one or more general language machine learning models. As discussed further above, a semantic layer in many embodiments of the invention can define a query structure appropriate for interfacing with a language model. Different types of query structures appropriate for different language models (e.g., LLM, entailment model, semantic context model) are described further below. The question posed to the language model may also request a summary of the message and/or confidence level of the answer it provides.

As described further below, each semantic query may be defined for a particular intent classification, so multiple queries may be run to explore which intent matches. In further embodiments of the invention, some additional logic may be used to limit which queries are run. For example, if some metadata or other aspect of the message implies that certain intent classifications would not be a match then the queries can be omitted from executing in response to the message. Furthermore, the logic can be formed as a decision tree or other structure, where branches indicate conclusions that subsets of intents and their associated semantic queries can be omitted.

The process then receives (506) an intent classification from the one or more language models of the text input and may also receive a prediction score representing the confidence of the classification. One or more business records actions responsive to the classification can be performed (508), e.g., if the text input was received in the course of a smartflow. For example, if the intent of the message is a request for an invoice, the process can continue to extract information used to identify the invoice (e.g., invoice number) and/or update any corrections to the invoice and send it to the requester in response to the message.

In some embodiments, a business records action can include constructing and sending an email requesting additional information for information fields to be saved back into the business records database.

In some embodiments, the intent classification can be inquiring status of a payment, and a business records action can include checking whether the requesting user account has authorization, querying a business records database for an invoice number, and providing to the user account information indicative of the processing status of the invoice number.

In some embodiments, the intent classification is updating a vendor record and a business records action can include receiving and storing additional information related to the vendor record in a business records database.

In some embodiments, the intent classification is receiving a new invoice and a business records action can include detecting that the request message includes a new invoice, processing the invoice, and updating a business records database to include the new invoice.

In some embodiments, the intent classification is requesting copy of a document, and a business records action can include identifying the requested document, retrieving the requested document from a business records database, and providing a copy of the requested document in response to the request message.

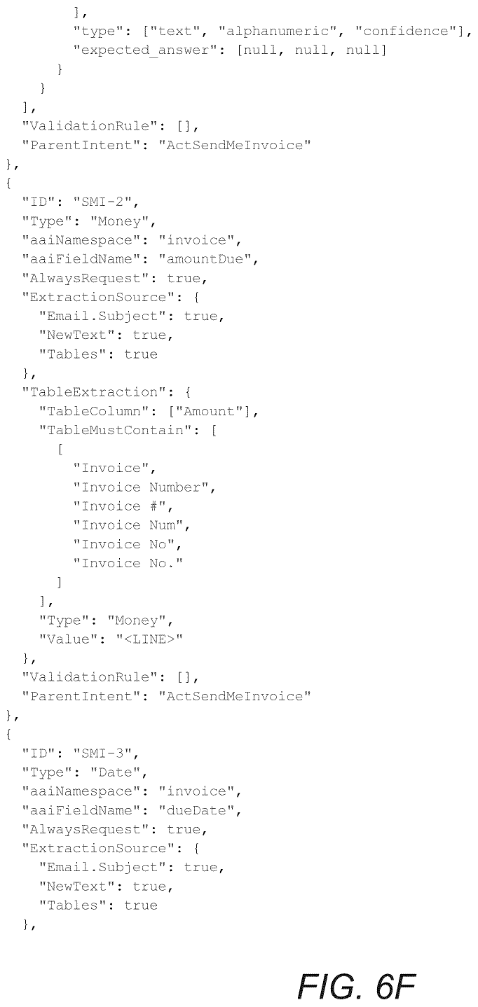

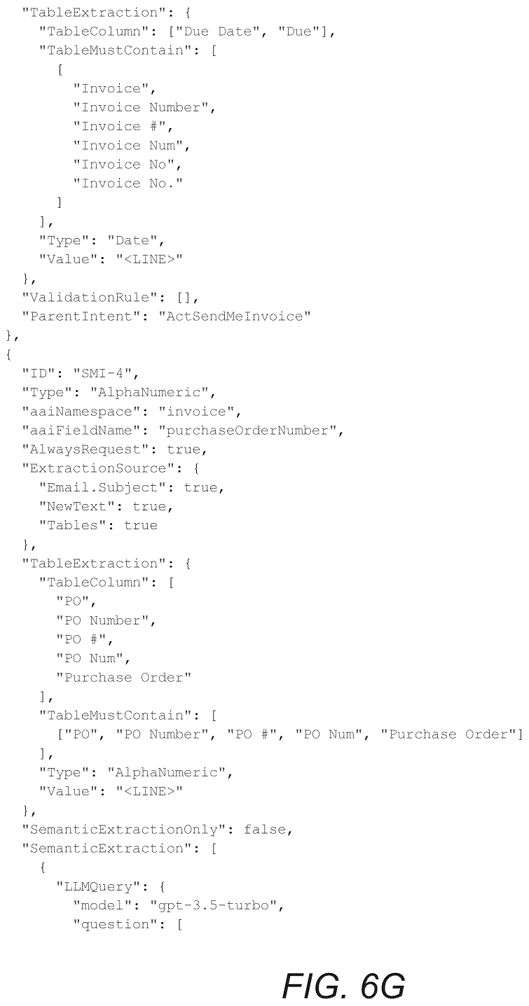

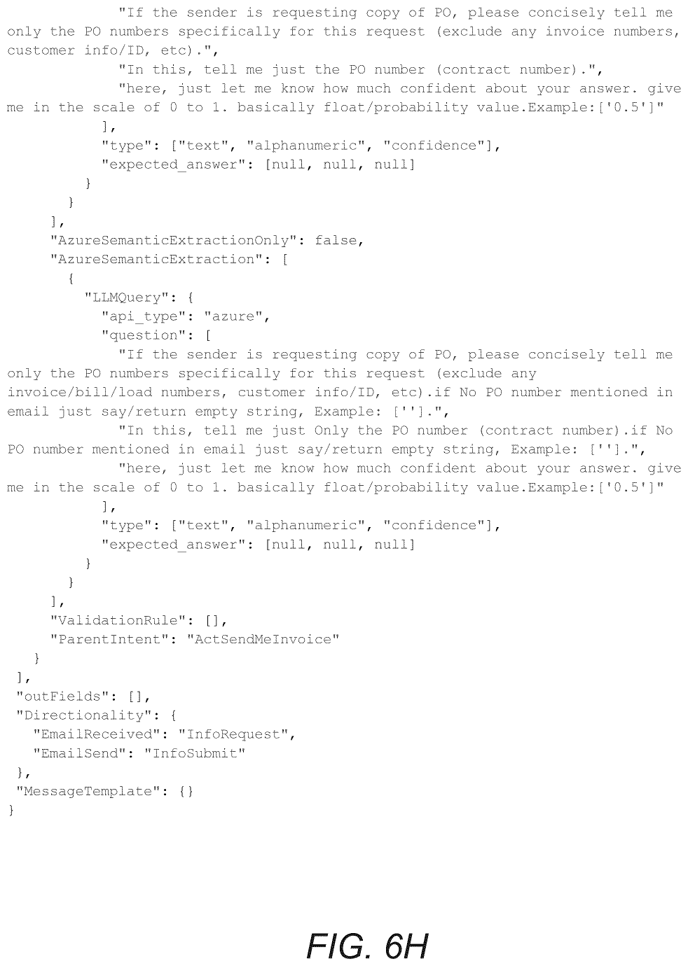

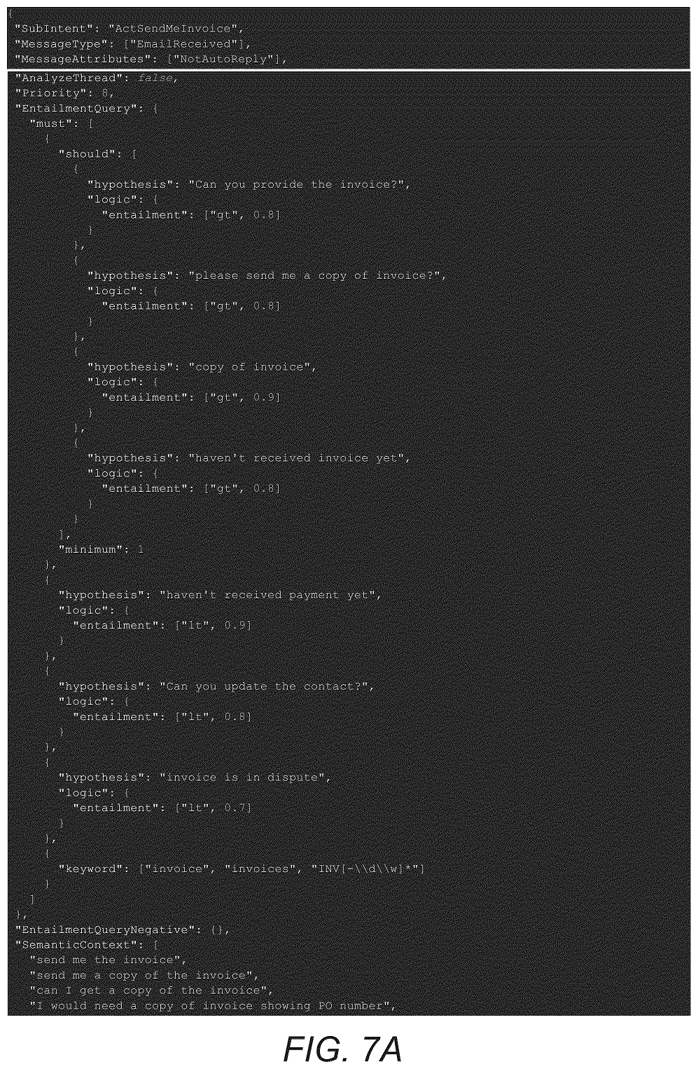

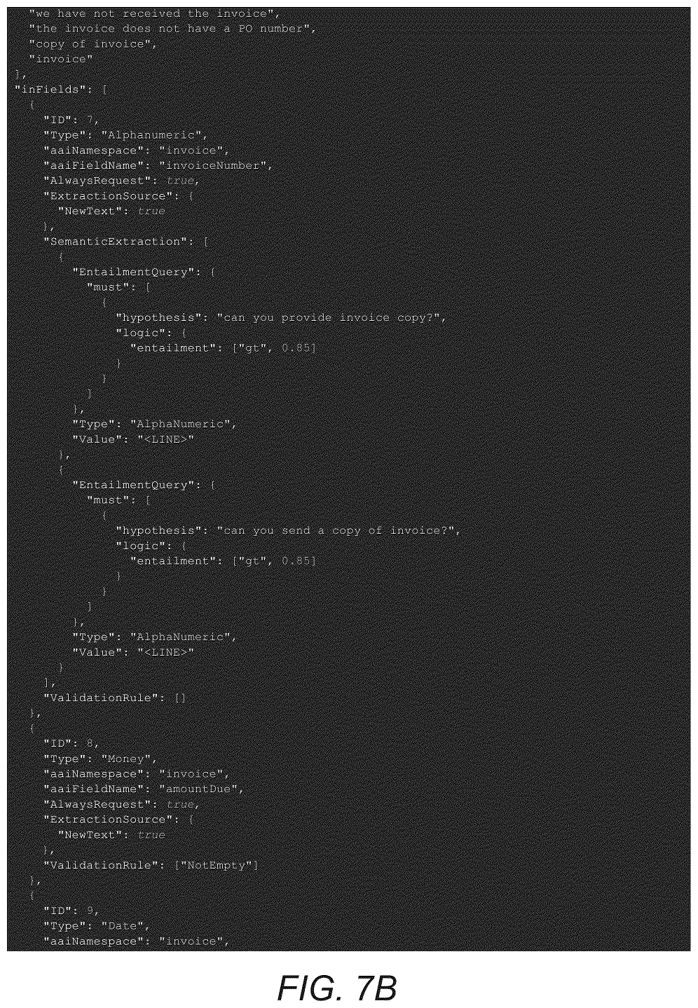

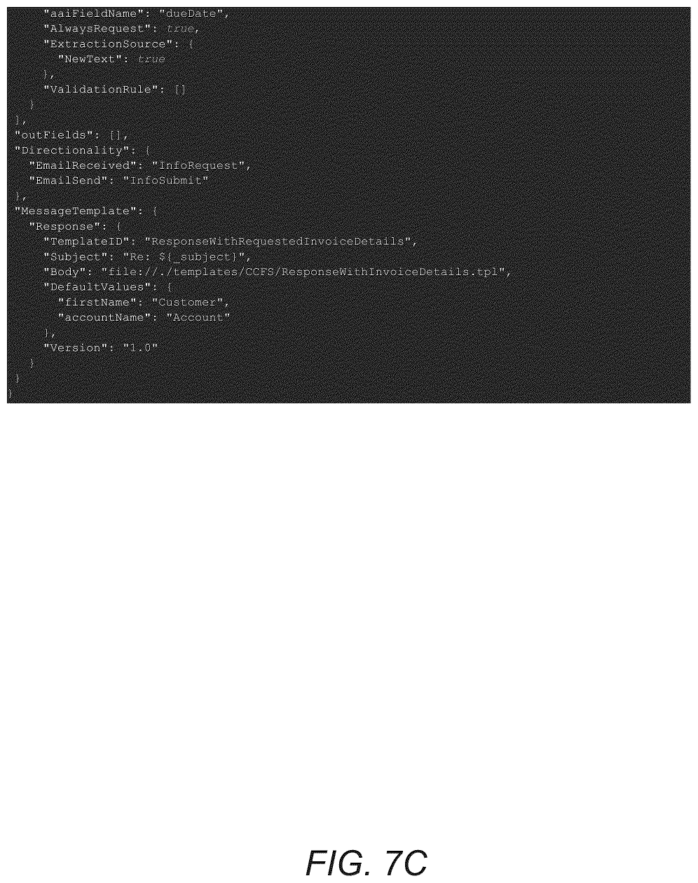

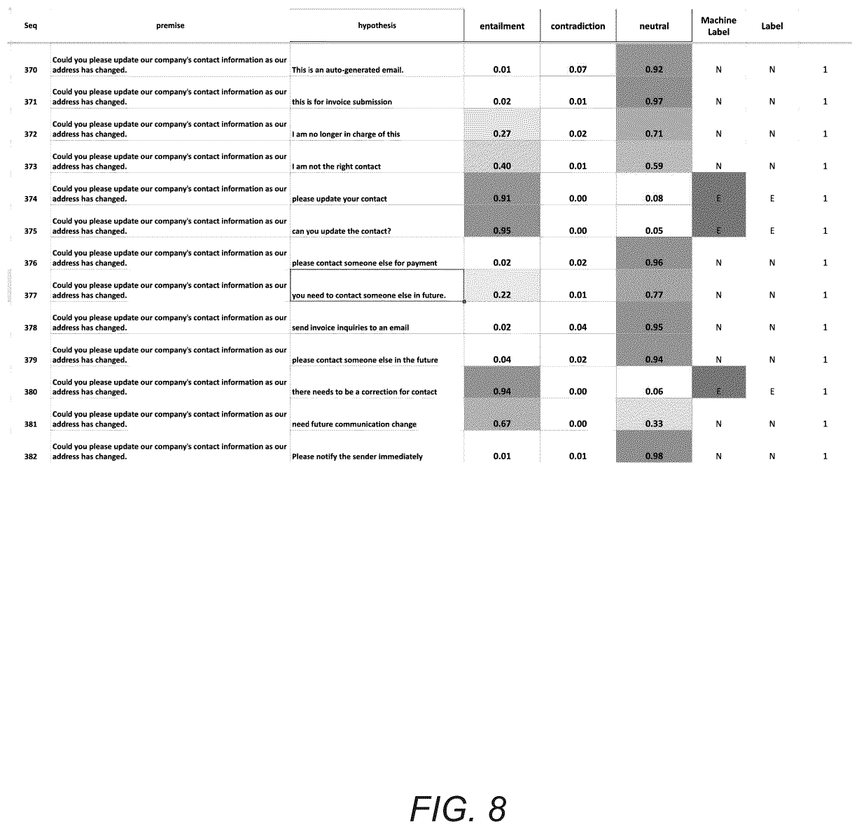

Although a specific process is described above with respect to FIG. 5, one skilled in the art will recognize that any of a variety of processes may be utilized in accordance with embodiments of the invention. Processes such as process 500 can be incorporated into smartflow processes to determine intent in processes such as those described further below with respect to FIGS. 7 and 8.

### Example Semantic Layer Query Structure—LLM

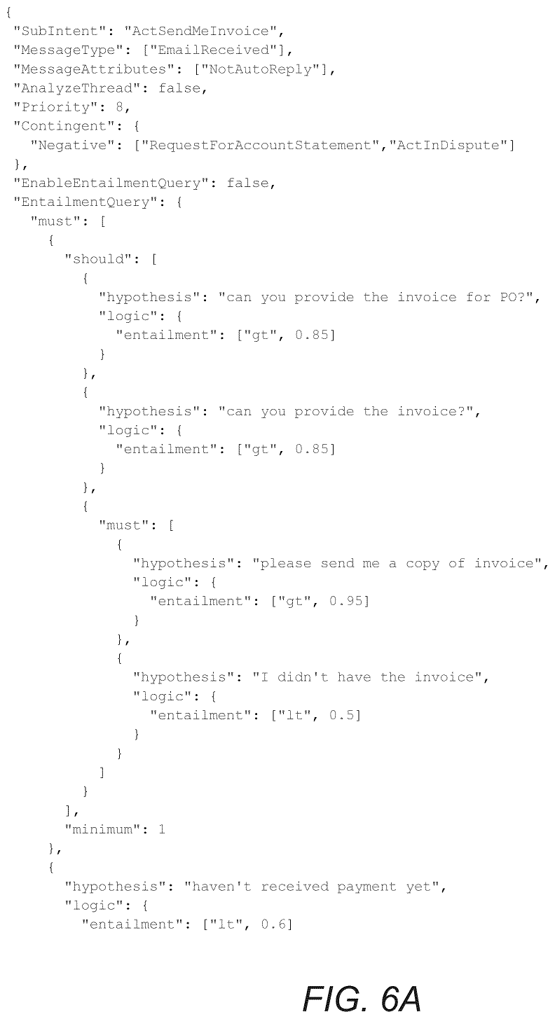

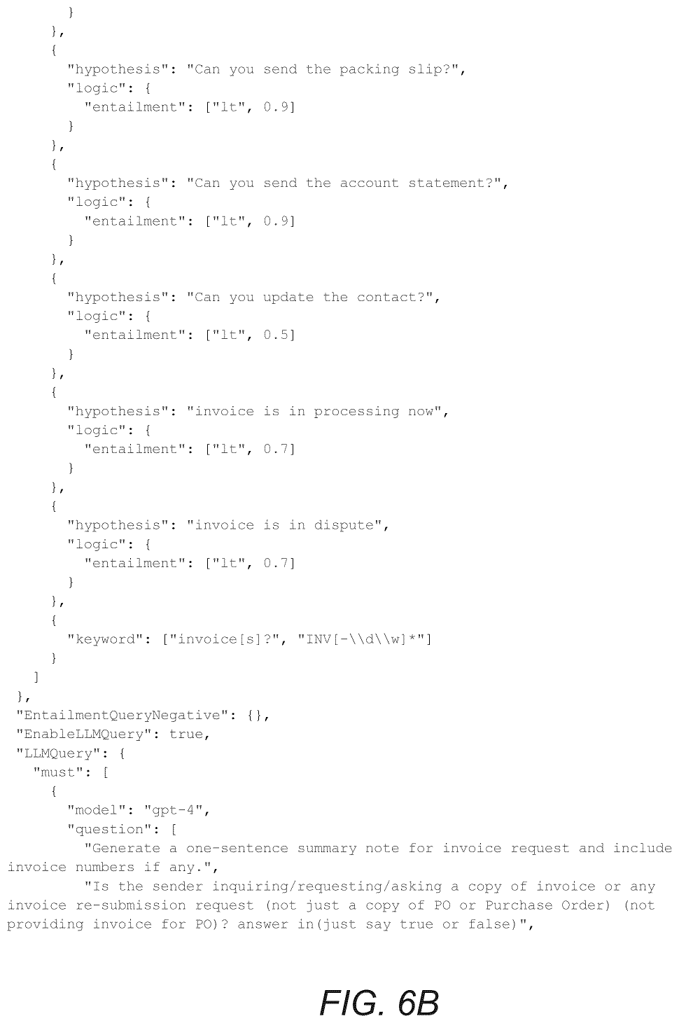

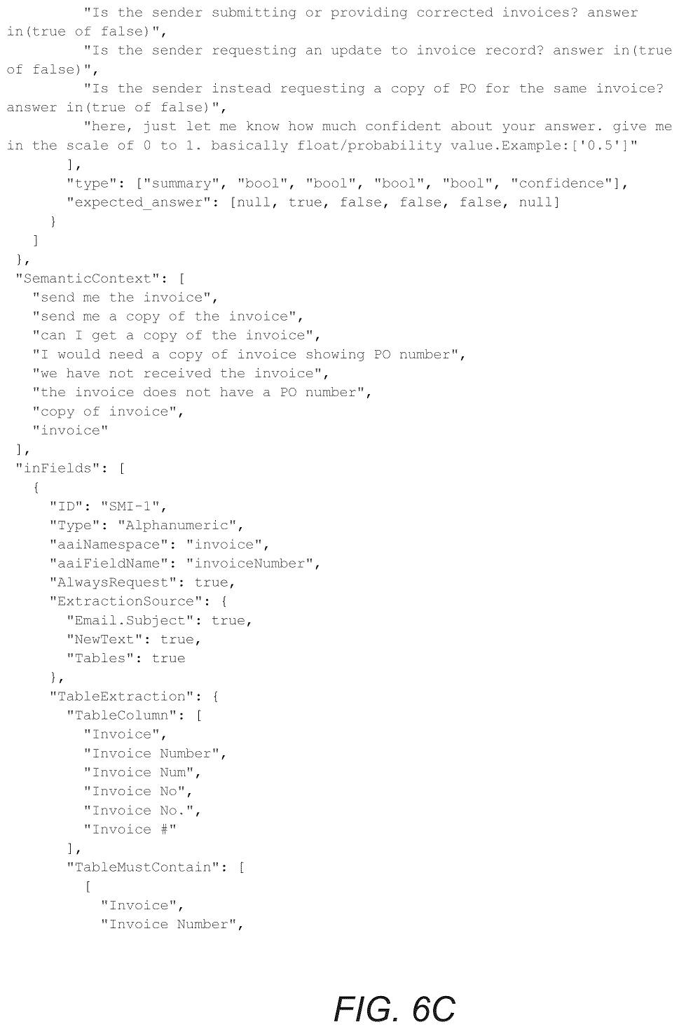

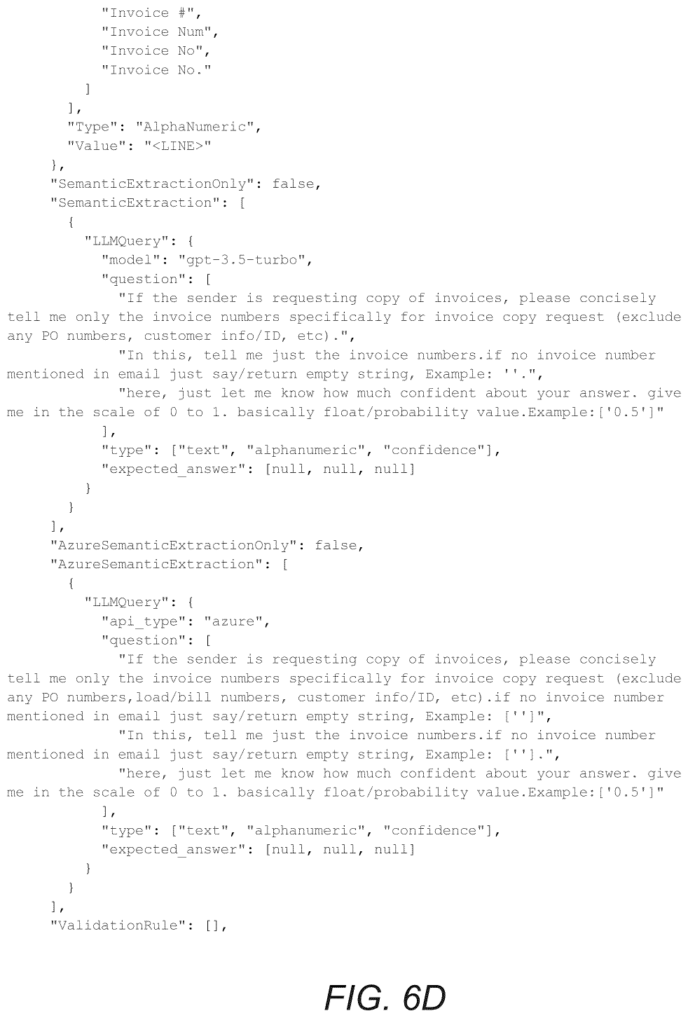

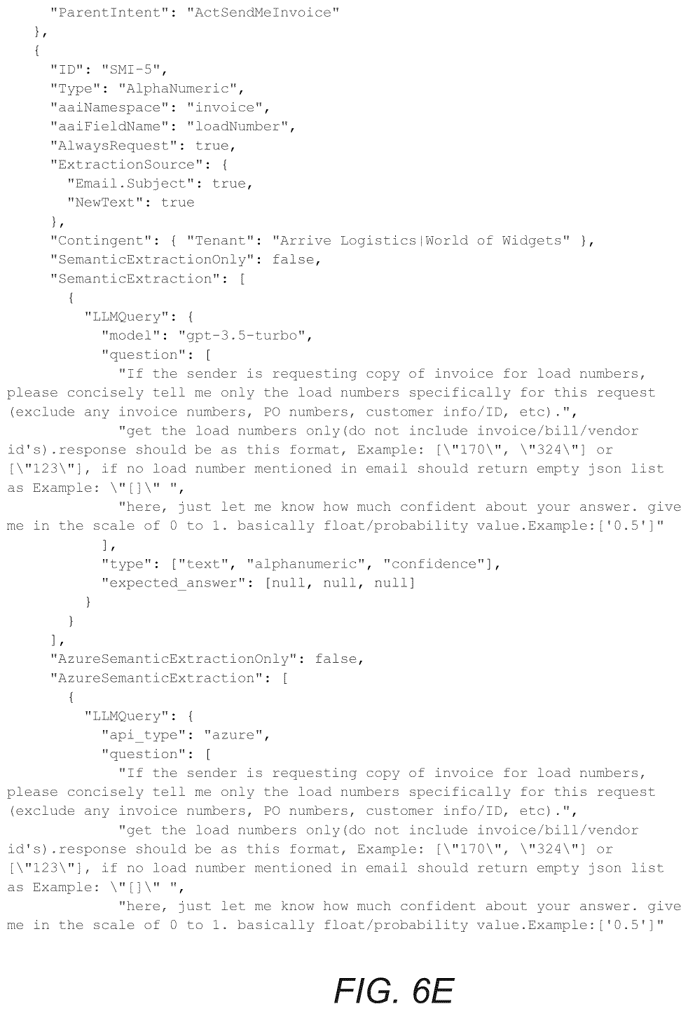

A semantic query for a particular intent suitable for interacting with a large language model (LLM) in accordance with embodiments of the invention can be structured with any or all of the following information that describes what information the query should use, how it should form a prompt for the LLM, and what the expected answer should look. An example of code for an LLM query is shown in FIGS. 6B-6H in the “LLMQuery” sections. The code includes at least one section for each intent to detect. The first intent in the example code is “ActSendMeInvoice” or “Send Me Invoice.” This intent is meant to detect when the message is a request to have an invoice sent to them. Additional intents can include their own code sections with the following information.

The code section can include an identification of which language model to incur. In the example, line “model”: “gpt-4” specifies a section of the query for feeding a GPT-4 model. Similarly, “model”: “gpt-3.5-turbo” and “api_type”: “azure” specify sections for feeding GPT-3.5 Turbo and Azure models, respectively.

The code section can include identification of what metadata from the received message (e.g., email) to pass to the language model. In the example, the “TableExtraction” section specifies what fields to extract from the message and provide to the language model.

The code section can include what prompt to provide to the language model for that intent query. The prompt can ask the model to make conclusions about the text input. In the example, the section for GPT-4 includes “question”: “Is the sender inquiring/requesting/asking a copy of invoice or any invoice re-submission request (not just a copy of PO or Purchase Order) (not providing invoice for PO)? answer in (just say true or false)”.

The code section can define how to interpret the output of the model. For example, the expected response can be defined by the format of the answers to the prompt, e.g., text summary, boolean true/false, numerical confidence level.

The code section can specify any certain information to be extracted from the message. In the example, the “inFields” section lists some criteria for finding and extracting an invoice number from the text input. The extracted information can be used for further processing, e.g., in a smartflow or other process that invoked the intent detection. Although a specific query structure is described above, one skilled in the art will understand that any of a variety of query structures may be utilized in accordance with embodiments of the invention.

### Example Semantic Layer Query Structure—Entailment Model

Sample code is shown in FIGS. 6A, 6B, 7A, 7B, and 7C for a query structure for use with an entailment ML model to determine if the intention of a message is to request an invoice. The “EntailmentQuery” section of the illustrated code presents a complex query structure with logical clauses combining each of the elementary model queries, according to an entailment model as described further above. Each elementary model query can handle a generic question (query) to the underlying machine learning model with a prediction score. The generic nature of these queries can be handled by properly pretrained general language model-based machine learning models without the need for domain specific training.

As discussed above, an entailment model can be designed to indicate whether statements A and B are related in that A logically implies B. Here, A can be the received input message. B can be one or more contextual sentences defined within the code of the semantic layer. The machine learning models can determine whether there is a “match” of the input being contextually related to one or more of the defined contextual sentences.

In the sample code, a positive result is returned as determining the context when the machine learning models indicate that the condition(s) within a “must” section are met and when the specified minimum number of conditions within a “should” section are met, with proper treatment of nested sections. Here, a positive result is found when the machine learning models indicate that the input is related to one of the hypothesis statements in the “should” section at confidence greater than (“gt”) the specified thresholds (e.g., 0.8, 0.9). Furthermore, the negative structure section following the “should section” and defines hypothesis statements that must be related at confidence less than (“lt”) the specified thresholds (e.g., 0.7, 0.8, 0.9) to indicate that they are not within the semantic context of the input. Additionally, a keyword section can define one or more keywords, one or more which must be present in the input message.

FIG. 8 illustrates a portion of example training data for an entailment model. Entailment models are still generic models, but typically need fine tuning with domain specific data to be responsive. The lines of the training data include a premise, hypothesis, and confidence values (zero to 1) for entailment (premise logically implies hypothesis is true), contradiction (premise logically implies hypothesis is not true), and neutral (premise and hypothesis are unrelated).

While a particular structure and example statements are shown in FIGS. 7A, 7B, 7C and 8, one skilled in the art will recognize that a different arrangement can be made and with different hypothesis statements to implement an entailment model in accordance with embodiments of the invention.

### Example Semantic Layer Query Structure—Semantic Context

In several embodiments of the invention, a semantic context query can find similarity of an input to one or more predetermined sentences by comparing distance in vector space. For example, the meaning of a message can be interpreted as requesting a copy of an invoice, without an exact word match in a specific order. To set up a semantic context model in some embodiments of the invention, convert every sentence of a set of sentences that help define the semantic context into a numerical embedding vector of a certain dimension (e.g., 1024×1 linear spaces) to encode the semantic meaning. Listing the semantic feature vectors defines a subspace, where each is a point forming a point cloud and the distribution of the point cloud is the subspace. A new input is taking as a point in vector space. Calculating how close it is to the defined point cloud can determine whether it is relevant to that semantic context (defined by the point cloud). The distance can be calculated using different techniques such as, but not limited to, cosine similarity or vector dot product similarity. Example code that defines semantic context queries in accordance with embodiments of the invention is shown in “SemanticContext” code sections in FIGS. 6C, 7A, and 7B. Although a specific query structure is described above, one skilled in the art will understand that any of a variety of query structures may be utilized in accordance with embodiments of the invention.

### Collecting and Unifying Business Records Data

Many databases, including typical records provider systems mentioned further above, are relational databases with information stored in tables and organized within columns. This structure imposes rigidity and can be difficult to adapt when integrating data from multiple systems. For example, customers may have data stored at different enterprise resource planning (ERP) systems, such as SAP, NetSuite or Sage Intacct. The data from different sources may not be easily combined. Those ERP systems may store the data in different formats or may require different application communication protocols or APIs to access the data, such as SOAP (Simple Object Access Protocol), REST (REpresentational State Transfer), or SuiteQL. Moreover, such systems typically do not capture data at a granularity (e.g., a frequency or a level of detail) that is useful for machine learning and artificial intelligence processes.

In many embodiments of the invention, business records data (e.g., payments, invoices, etc.) from different data sources (records provider systems), which may be in different source formats, can be normalized by converting it to a single representation of a common data model, referred to here as a unified format, by a transformation engine in the integration platform. This conversion can be referred to as an inbound data flow. Converting data from the unified format to an output format (e.g., for exporting back to an ERP system, generating reports for a user interface, etc.) can be referred to as an outbound data flow. The transformation engine can include a service model and library to facilitate transformation of data. The library can include specifications referred to as data definitions and transformation rules.

Entities that interact can be represented by generic schemas at the database layer. In some further embodiments, a platform-independent standard language such as Extensible Business Reporting Language (XBRL) is used to express information and logic of business records data. Business records data can be stored in either XML or JSON schema representation in a central data store. Any of a variety of database types can be used for the central datastore, such as, but not limited to, Cassandra, MySQL, and Neo4J.

In many embodiments of the invention, the transformation engine in the integration platform maintains a bidirectional mapping to convert data format of certain records provider systems into others. For example, in a third normal form (3NF) of data modeling, attributes can be represented as a column and relations in sets of tables using JSON or similar language as a payload to describe the data in a schema-less fashion. In some further embodiments, additional data is added in the unifying process in order to facilitate machine learning and/or artificial intelligence processes to be performed on the data.

Some additional processes may be utilized to convert data from the unified format to a source format. This conversion can be referred to as an outbound data flow.

Conversational intent detection on interactions with records provider systems can be performed in multiple stages. The integration platform can learn programmatically the rules and circumstances of how to interface with records provider systems to obtain business records data. Canonical definitions of objects and entities in business records data may differ from one records provider system to another, or may change with additional versions of a particular system over time. In some instances, it may be desirable to avoid hard coding decision statements such as for loops and if statements, however they can accommodate expressions provided for natural language processing (NLP) if necessary.

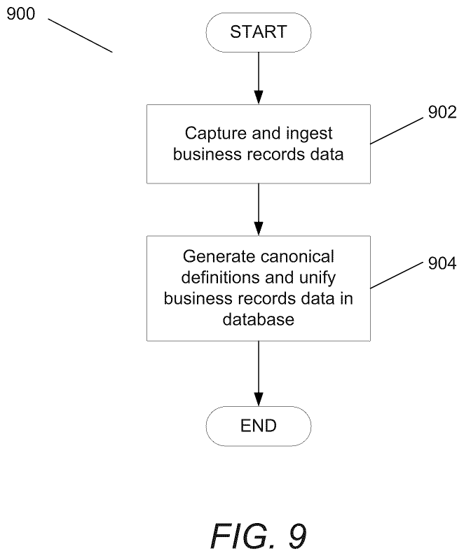

A process for normalizing business records data in accordance with embodiments of the invention is illustrated in FIG. 9. In certain embodiments the process 900 can be performed on or by an integration platform. The process 900 includes capturing and ingesting (902) business records data. The transfer can be performed, for example, using APIs. In several embodiments, at least some data sources are enterprise resource planning (ERP) systems. The process then generates canonical definitions and unifies (904) the business records data in a business records database.

Further embodiments of the invention include receiving and unifying additional business records data. Additional sets of data can be received from the same and/or other data sources. A second set of business records data is received.

Although a specific process for unifying business records data into a single format is described above with respect to FIG. 9, one skilled in the art will recognize that any of a variety of processes may be utilized in accordance with embodiments of the invention. Such processes may be performed using hardware such as an integration platform as discussed further above.

### Processes for Adaptively Automating Business Processes

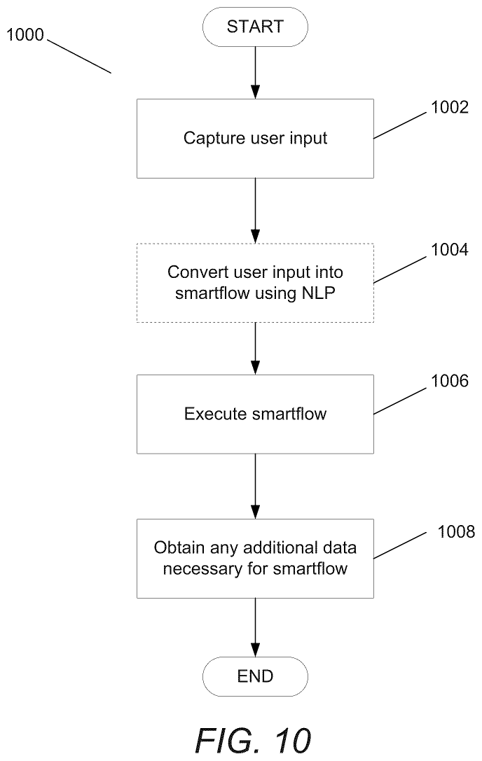

A process for autonomously analyzing business records data to perform a business process in accordance with embodiments of the invention is illustrated in FIG. 10. In certain embodiments the process 1000 can be performed on or by an integration platform. The process includes capturing (1002) an expression of a business process in text or audio. In many embodiments, the business process can be described in natural language as typed by a user into a user interface. For example, a user interface console can be provided on a webpage or in a dedicated application.

The text or audio is parsed and interpreted (1004) using natural language processing (NLP) to generate a state model where the initial state expresses what information was provided, what information is known, and what information is still needed. Different approaches may be utilized to determine rules for the state model. In several embodiments, the input text is decomposed into units that can be recomposed based on need. A simple example is an item that requires the approval of a particular person.

The NLP process may parse the text or audio to create rules that govern the transition from one state to another based on additional interactions. For example, a state may require validating the fields of a form to check that they are completed correctly (e.g., fields have valid values, only one of a group of checkboxes is filled, etc.). If there are inconsistencies or unacceptable entries, the state can transition to a state that deals with such an error, for example by returning the form to the other party and providing a message directing to the problematic areas of the form. Such errors states may be repeated for a predetermined number of times to attempt to have the other party correct the error. After the number of tries is exhausted, these errors may result in escalation for review by a human user. Similarly, other types of errors that are not contemplated or unresolvable can be escalated.

When the state model is executed (1006), the process accesses the records data to be utilized. The records data may already be present in the business records database 106 or additional records data may be retrieved (1008). As discussed further above, records data (e.g., payment, invoice, etc.) may be in different formats, for example, from different provider systems (e.g., ERP providers, electronic health records, etc.). The records data is converted into a single view to remove characteristics that are specific to the provider systems (e.g., column length/type, etc.) and change metadata to common meanings. In several embodiments, the conversion incorporates machine learning or other adaptive or manual learning techniques to account for the format of records data potentially changing over time. Some vendors may update their systems anywhere from two to four times a year, so there can be new data objects or changes to existing data objects. For example, cohort analysis may be utilized in data ingestion to learn relationships.

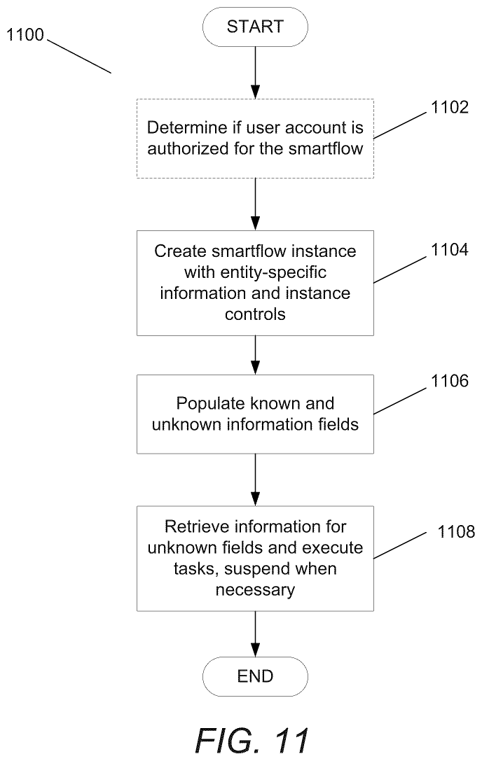

A process for executing a smartflow in accordance with another embodiment of the invention is illustrated in FIG. 11. The process 1100 includes receiving 1102 a smartflow execution request from a user account and determining if the user account that is initiating the smartflow is authorized to do so. For example, the user account may be assigned to a role that has permissions to execute the smartflow.

The process includes creating 1104 a smartflow instance. In some embodiments, this can include starting a microservice (e.g., using a virtual machine or serverless application). Several embodiments utilize AWS (Amazon Web Services) Step Functions as a microservice for smartflows. AWS Step Functions provides SDKs (software development kit), APIs (application programming interface), and integrations with the AWS ecosystem. The smartflow instance is provided with entity-specific information and instance controls.

In some embodiments of the invention, a smartflow may be expressed in JSON format. A smartflow can also be visualized as a flow chart.

Returning to FIG. 11, the process populates 1106 information fields that are used by the smartflow. Some information fields may be known (e.g., that can be retrieved from the business records database) and some information fields may be unknown (e.g., that can be retrieved from an external source, ERP system, etc.). A variety of techniques, including those discussed further above, may be utilized to retrieve information to populate the information fields in accordance with embodiments of the invention.

The data corresponding to unknown fields are retrieved 1108 and tasks encoded into the smartflow are executed according to the state machine. In several embodiments of the invention, at least two mechanisms may be utilized to obtain data for the information fields. First, an email notification service may construct one or more emails to recipients that may have the desired data. Several embodiments utilize natural language models to generate an email, which can be based on features such as the smartflow state, smart templates, rendering, etc.

The email notification service can then listen for a response. When a response is received, an intent detection process can be performed to match the response to the smartflow that is expecting it (e.g., when there are multiple smartflows). The intent detection process may utilize natural language processing as part of the matching to determine the purpose of the received email (e.g., send or receive information, dispute an issue, etc.).

The data can be extracted from the email response text and attached documents (e.g., using language model intent detection, natural language processing, OCR, and/or various information extraction techniques), matched to standard data records, and provided to the smartflow. Certain embodiments of the invention can include email exchanges that are completely automated without human intervention. Such email exchange processes can include email generation, incoming email intent parsing, information extraction, and record updating by, for example, the integration platform. Other embodiments may integrate human review, approval, and/or information seeking into the smartflow through a user interface. For example, an email request may be sent for supervisor/manager approval, to request an invoice copy, etc.

Second, an ERP record query can be sent to an ERP system that may have the desired data. The ERP system can respond to the query with the requested records.

Any tasks that are encoded into the smartflow are performed according to the state model of the smartflow. In some embodiments of the invention, tasks can include a numerical/quantitative analysis performed using data in the information fields. For example, a smartflow may produce a cashflow forecast using a backend process to generate the forecast and report it out to a user. Other tasks can include reading or writing to customer ERP systems. In further embodiments of the invention, smartflow modules can group certain related functionality in subflows. The smartflow modules can replicate across different smartflows where similar functionality is used.

Although certain processes are discussed above with respect to FIGS. 9-11, one skilled in the art will recognize that any of a variety of processes may be utilized in accordance with embodiments of the invention. Such processes may be performed using hardware such as an integration platform as discussed further above.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method for detecting intent of a textual message, the method comprising:
receiving a request message;
extracting text and metadata from the request message;
executing a plurality of semantic queries to determine an intent of the request message, by, for each semantic query:
where the semantic query specifies at least one machine learning language model to be used, and what text and metadata from the message and what textual prompt to provide to each at least one machine learning language model, and a formatting template specifying how an expected answer from each at least one machine learning language model should be formatted;
providing at least some of the extracted text and metadata and a textual prompt to each at least one machine learning language model as specified in the semantic query;
receiving an answer from each at least one machine learning language model that includes an indication of an intent classification; and
performing a corresponding business action in response to the indicated intent classification.

2. The method of claim 1 wherein the answer from the machine learning model further comprises a confidence level that the intent classification is accurate.

3. The method of claim 1 wherein the answer from the machine learning model further comprises a summary of the extracted text.

4. The method of claim 1, wherein the semantic query further comprises criteria for finding and extracting an identification of a business record from the extracted text.

5. The method of claim 4, wherein the taking an action in response to the indicated intent classification further comprises:
identifying a portion of the extracted text that identifies a business record in response to the indicated intent classification and retrieving the identified business record.

6. The method of claim 1, where one of the at least one machine learning language model is a large language model (LLM) and the semantic query further comprises:
a prompt that includes at least one true/false (Boolean) question.

7. The method of claim 1, where:
one of the at least one machine learning language model is an entailment model, where a premise statement is matched to an input and an associated hypothesis statement defines the intent classification; and
the semantic query further comprises at least one hypothesis statement for matching with a portion of the extracted text and an associated threshold for returning a positive match for that hypothesis statement.

8. The method of claim 1, where:
one of the at least one machine learning language model is a semantic context model, where sentences that define a semantic context for a given target intent classification are represented as numerical embedding vectors in vector space to encode the semantic meaning; and
the semantic query further comprises converting a portion of the extracted text to a point in vector space and calculating a distance from the point to at least one numerical embedding vector.

9. The method of claim 8, where:
calculating a distance utilizes cosine similarity as a metric for comparison.

10. The method of claim 8, where:
calculating a distance utilizes vector dot product similarity as a metric for comparison.

11. A method for executing an autonomous business records data process, the method comprising:
receiving a request from a user account for executing a business records data process, where the business records data process comprises a state model specifying types of input data, execution tasks, and output data while maintaining a current state;
creating an execution instance of the state model for the requested business records data process and allocating information fields;
executing the state model of the business records data process;
receiving a request message while executing the state model;
extracting text and metadata from the request message;
executing a plurality of semantic queries to determine an intent of the request message, by, for each semantic query:
where the semantic query specifies at least one machine language model to be used, and what text and metadata from the message and what textual prompt to provide to each at least one machine learning language model, and a formatting template specifying how an expected answer from each at least one machine learning language model should be formatted;
providing at least some of the extracted text and metadata and a textual prompt to each at least one machine learning language model as specified in the semantic query;
receiving an answer from each at least one machine learning language model that includes an indication of an intent classification; and
performing a corresponding business action in response to the indicated intent classification.

12. The method of claim 11, further comprising retrieving information to fill the information fields from one or more business records databases.

13. The method of claim 12, wherein information fields include a client identification.

14. The method of claim 11, wherein performing a corresponding business action comprises constructing and sending an email requesting additional information for at least one of the information fields.

15. The method of claim 11, wherein performing a corresponding business action comprises obtaining and storing additional information for at least one of the information fields and storing the information to a business records database.

16. The method of claim 11, wherein the intent classification is inquiring status of a payment, and performing a corresponding business action comprises check whether the user account has authorization, querying a business records database for an invoice number, and providing to the user account information indicative of the processing status of the invoice number.

17. The method of claim 11, wherein the intent classification is updating a vendor record and performing a corresponding business action comprises receiving and storing additional information related to the vendor record in a business records database.

18. The method of claim 11, wherein the intent classification is receiving a new invoice and performing a corresponding business action comprises detecting the request message includes a new invoice, processing the invoice, and updating a business records database to include the new invoice.

19. The method of claim 11, wherein the intent classification is requesting copy of a document, and performing a corresponding business action comprises identifying the requested document, retrieving the requested document from a business records database, and providing a copy of the requested document in response to the request message.

20. A method for detecting intent of a textual message, the method comprising:
receiving a request message;
extracting text and metadata from the request message;
executing a plurality of semantic queries to determine an intent of the request message, by, for each semantic query:
where the semantic query specifies a large language model (LLM) machine learning language model to be used, what text and metadata from the message to provide to the machine learning language model, a textual prompt to provide to the machine learning language model that includes at least one true/false (Boolean) question, a formatting template specifying how an expected answer from the machine learning language model should be formatted, and criteria for finding and extracting an identification of a business record from the extracted text;
providing at least some of the extracted text and metadata and a textual prompt to each machine learning language model as specified in the semantic query;
receiving an answer from each at least one machine learning language model that includes an indication of an intent classification and a confidence level that the intent classification is accurate; and
performing a corresponding business action in response to the indicated intent classification.
